(19) United States
(12) Patent Application Publication
(10) Pub. No.: US 2005/0278375 A1
(43) Pub. Date: Dec. 15, 2005

(54) Asset management system and associated methods

(76) Inventors: Stephanie Mitchko, Smithtown, NY (US); Kiran Bhongiri, Hauppauge, NY (US); Peter Caramanica, Westbury, NY (US); Ernest Chen, Brooklyn, NY (US); James Dammers, Bayside, NY (US); Louis Fischetti, East Northport, NY (US)

Correspondence Address: KENYON & KENYON, 1500 K STREET NW, SUITE 700, WASHINGTON, DC, 20005, US

(21) Appl. No.: 10/853,189

(22) Filed: May 26, 2004

(51) Int. Cl. G06F 7/00

(52) U.S. Cl. 707/104.1

(57) ABSTRACT

A method and apparatus prepare an asset for placement on a server, the asset including a media file and corresponding metadata elements. The media file is received, and it is automatically determined whether all required metadata elements are associated with the received media file. If all of the required metadata elements are not associated with the received media file, it is determined which of the required metadata elements are missing, and the missing metadata elements are required to be added before the asset is placed on the server.

### TECHNICAL FIELD

The present invention relates to systems and methods for management of assets. The assets may include media files and associated metadata.

### BACKGROUND OF THE INVENTION

Providers of video content, such as cable companies, are converting from analog delivery systems to more sophisticated digital delivery systems. These systems are being deployed, and will, over time, phase out the analog delivery systems. For example, cable companies are offering digital set top boxes to customers, that offer more viewing choices to the customer. These digital set top boxes may offer additional features and services such as additional channels, interactive user interfaces, digital programming, pay-per view, video-on-demand, subscription video-on-demand, etc.

In the area of video-on-demand (VOD) and subscription video-on-demand (SVOD), the provider of these services, such as a cable company, must be able to make the assets (the media programs and associated metadata) available to customers as efficiently as possible. The media files may be provided by a content provider to a cable company with a start date and an end date, which provides a window during which the media programs may be offered to customers on a video-on-demand basis.

Typically, such VOD assets are placed on a VOD server, which can communicate with a customer's set top box to offer and deliver the assets to the customer when they are ordered. Such systems typically deliver the assets to the set top box in an encoded form, as well known to those of skill in the art.

However, the service provider must take certain steps to make the assets ready to be placed on the VOD server. The video programs may be received from different content providers, and are often received in different formats. For example, some video programs may be delivered to the service provider on video tape that has not been encoded. Other content providers may deliver the programs to the service provider by satellite in an encoded form. Content providers may also deliver the programs with no metadata or with some metadata. Such metadata is usually arranged in a separate file or files and may include items such as a title, a description, and a program rating, for instance.

Even when some metadata is provided by the content provider, it may not be all the metadata that the service provider needs, and may not be in the proper format needed by the service provider. The service provider may have developed certain categories of metadata that need to be entered for each media program, so that a uniform display may be provided to the customer. Specifications have been developed by the cable industry that specify how to create content for video-on-demand services. These include the CableLabs® Video-On-Demand Content Specification Version and the CableLabs® Asset Distribution Interface Specification Version. These specifications specify required and optional metadata for use with video-on-demand assets. A service provider, such as a cable company, may have to ensure that the required and/or optional metadata is present for each asset, and if not present, may have to add missing metadata.

Accordingly, the service provider is often presented with a series of steps that have to be done for the media program assets before they can be offered to customers, and these steps may be different for individual media programs depending upon the format received from the content provider and whether any metadata is received. Further, the service provider may receive a large number of such media program assets, resulting in delay in moving the assets into the proper condition to be offered to customers, resulting in a loss in profitability. Such delays may be especially troublesome when the assets have an expiration date set by the content provider, after which the service provider may no longer offer the asset to customers.

### SUMMARY OF THE INVENTION

A method and apparatus prepare an asset for placement on a server, the asset including one or more media files and corresponding metadata elements. The media file is received, and it is automatically determined whether all required metadata elements are associated with the received media file. If all of the required metadata elements are not associated with the received media file, it is determined which of the required metadata elements are missing, and the missing metadata elements are required to be added before the asset is placed on the server.

### BRIEF DESCRIPTION OF THE DRAWINGS

FIG. 1 is a block diagram in accordance with an embodiment of the present invention.

FIG. 2 is a block diagram in accordance with an embodiment of the present invention.

FIG. 3 is a block diagram in accordance with an embodiment of the present invention.

FIG. 4 is a flowchart in accordance with an embodiment of the present invention.

FIG. 5 is a flowchart in accordance with an embodiment of the present invention.

### DETAILED DESCRIPTION

The present invention enables a service provider, such as a cable company, to receive video programs in different states of readiness, and to quickly and efficiently place the programs in a state to be placed on a server to be delivered to customers. As used herein, an asset is defined as a combination of a physical media file (such as a video program, audio content, an image file, etc.) and certain required metadata information. As used herein, metadata is descriptive data associated with an asset. The required metadata information is needed for each media file, so that a uniform display of information can be provided to the customer, as further explained below. The required metadata may be set by a standard (such as those described above), or may be determined by the individual service provider. The media files may be received in an encoded format, or in an non-encoded format, and may be received with no metadata, with some metadata, or with all the required metadata that is needed. Optional metadata may also be provided.

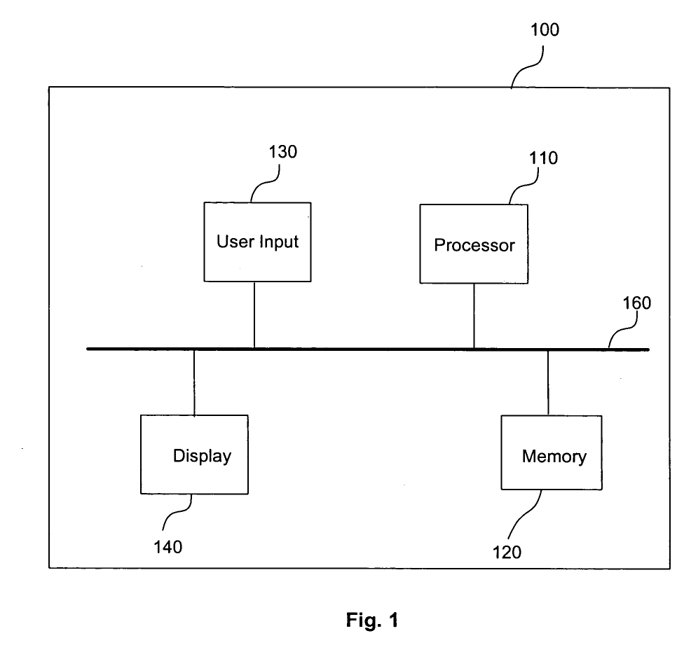

FIG. 1 depicts a block diagram of an embodiment of the present invention. Computing device 100 is suitable for use with the present invention. The computing device 100 may include a processor 110, a memory 120, a user input 130, and a display 140. The memory 120 may contain software to be run in conjunction with processor 110, and may cause images to be displayed on display 140. The software is specifically designed to cause computing device 100 to implement the present invention. Computing device 100 may be one of various types of computing devices, such as a workstation, a personal computer, a server, a head-end in a cable system, or any other type of computing device.

The processor 110 may be a general-purpose microprocessor, such a Pentium series microprocessor manufactured by the Intel Corporation of Santa Clara, Calif. In another embodiment, the processor 110 can be an Application Specific Integrated Circuit (ASIC), which has been designed to implement in its hardware and/or firmware at least a part of a method in accordance with embodiments of the present invention.

Memory 120 can be any device capable of storing analog or digital information, such as a hard disk, Random Access Memory (RAM), Read Only Memory (ROM), flash memory, a compact disk, a magnetic tape, a floppy disk, and any combination thereof, for example.

User input 130 can be any type of input device, such as a keyboard, keypad, pointing device, microphone, mouse, wired or wireless remote control, touch pad, touch screen, a port(s) to attach other input devices, voice recognition software, etc. Any type of input device will function in accordance with embodiments of the present invention.

The display 140 can be any type of display or screen that is capable of displaying images. For example, the display may be a CRT or LCD monitor, a heads-up display, a television, etc. The display 140 may be structurally included as part of the electronic device, or may be physically separated from but connected with the other components of device 100, such as a monitor in a desktop computer.

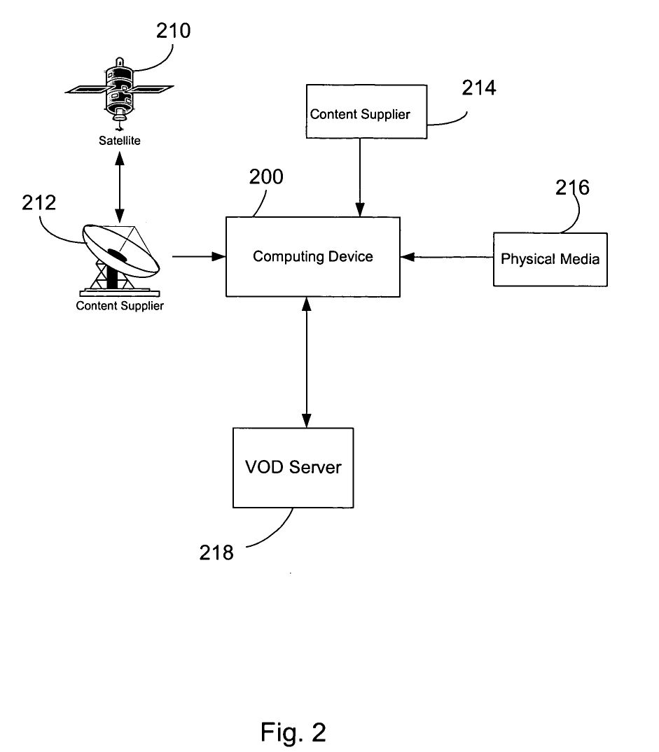

FIG. 2 depicts a block diagram of an embodiment of the present invention. The computing device 200 corresponds to the computing device 100 of FIG. 1, and may include the processor 110, the memory 120, the user input 130 and the display 140, as well as other computer elements. The computing device 200 receives content, which may include one or more media files, and may include metadata associated with each media file. The media file may be encoded when received from a content supplier, or may not be encoded. The media files may be received in any electronic or non-electronic format.

The computing device 200 may receive the media file or files and/or associated metadata in several ways. First, the computing device 200 may receive the media files and/or associated metadata transmitted from a content supplier from a satellite 210, where the signal is received at a station 212, and then transmitted to the computing device. These media files are typical encoded when sent over the satellite 210 in digital format, but could be received without being encoded.

Second, the computing device 200 may receive the media file or files and/or associated metadata transmitted from a computer network 214 operated by the content supplier. The associated metadata from the computer network 214 may be sent electronically in XML format, for example, although other formats could be used. The media files may be encoded or not encoded.

Third, the computing device 200 may receive the media file or files and/or associated metadata on physical media 216, which may be a tape or disc, for example. In this case, the media file or files and/or associated metadata may be manually entered into the computing device 200. The video programs and/or associated metadata may be encoded or not encoded. Other methods of receipt are also usable with embodiments of the present invention.

The computing device 200 may receive a large number of the media files and/or associated metadata transmitted from content suppliers in differing states of readiness to be placed on the VOD server 218. To be placed on the VOD server 218, the media files and associated metadata must have all the required metadata, and be encoded. The encoding may be in one of several different formats, such as MPEG, for example.

Accordingly, the present invention automatically checks the received media files to determine whether the required metadata is present. This is accomplished with the use of a software program in the computing device 200. The software program may be specifically developed in order to prepare assets to be placed on the video-on-demand server 218. The computing device 200 thus automatically checks the received media files and/or metadata to determine whether they include the required metadata. As further explained below, the computing device is programmed with a series of process steps. If the computing device determines that all of the required metadata is present, the computing device can skip one or more of these steps. However, if some or all of the required metadata is missing, the computing device 200 will need to carry out additional steps to add the required metadata prior to placing the assets on the video-on-demand server 218. For example, the computing device 200 may detect he missing metadata may be manually entered by user input 130, for example.

The required metadata may include, but is not limited to, a title, a description, activate and deactivate dates, a subscription group, categories, a release year, a length, a rental period, a grace period, and a price. The metadata may be referred to as metadata elements. There may be additional optional metadata elements that may or may not be included in the asset. For example such optional metadata could include, but are not limited to, a summary, an episode name, and episode ID, an MSO rating, advisories, an indication of closed captioning, a country of origin, an encryption flag, etc. Many additional metadata are included in the Cable Labs® specifications described above. Any or all of these metadata categories could be designated as required metadata or as optional metadata, by a particular service provider, for example. However, in an aspect of embodiments of the present invention, the computing device 200 will automatically check to see if the metadata elements that have been designated as required are present upon receipt of the media file. Although not required, the present invention could also be configured to automatically look for one or more categories of metadata that may have been designated as optional, as desired by a user or service provider.

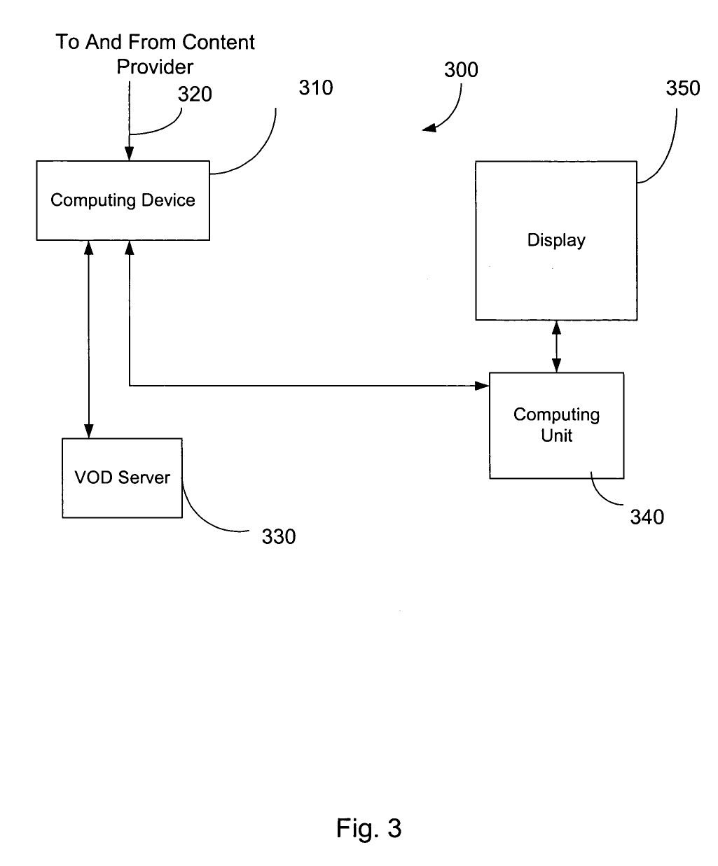

FIG. 3 illustrates a system 300 that may be used in accordance with embodiments of the invention. Computing device 310 may be the same as computing device 200 of FIG. 2. Computing device 310 receives media files and/or metadata from content providers through inputs 320, which may be received from satellite, electronically, or on physical media as discussed above concerning FIG. 2. The computing device 310 receives the media files and determines whether certain required metadata is present. If the required metadata is present, the computing device may send the asset (the media file and associated metadata) to the VOD server for storage, where it can be offered to customers. Prior to sending the asset to the VOD server 330, the computing device 310 may perform additional steps on the asset. For example, the asset may be encoded, as well know to those of skill in the art. Additionally, the computing device may be used to perform any additional desired steps on the asset. Further, the computing device 310 may be one computing device, or a plurality of computing devices.

The computing device 310 may be a computing device at a cable television provider's facility, such as at a head end or other facility. The computing device 310 may be connected to a computing unit 340, which may be located at a subscriber location. For example, the computing unit 340 may be a set top box offered by a cable television company located in a subscriber's dwelling. The display 350 may be a conventional television connected to computing unit 340. As in conventional systems, a subscriber may be offered movies or other programs on a video-on-demand or pay-per-view basis. These programs may be ordered through the computing unit 340, or by other means such as by telephone. Commands may be sent through the computing unit 340 to the computing device 310, to order a desired program. The order may be received by the computing device 310, or by another computing device located at a facility of the service provider. The computing device 310 or a device receiving the order the may send signals to the VOD server 330 to deliver a signal including the desired asset, which may be directed to the computing unit 340 for display on the users display 350. Alternatively, the computing unit 340 could send signals directly to the VOD server 330 to order the desired program.

The VOD server will thus have a plurality of assets loaded onto it, each including a media file and associated metadata. The computing device 310 insures the integrity of this important association. The assets include metadata required by the service provider or by the above-described standards, and may additionally include optional metadata.

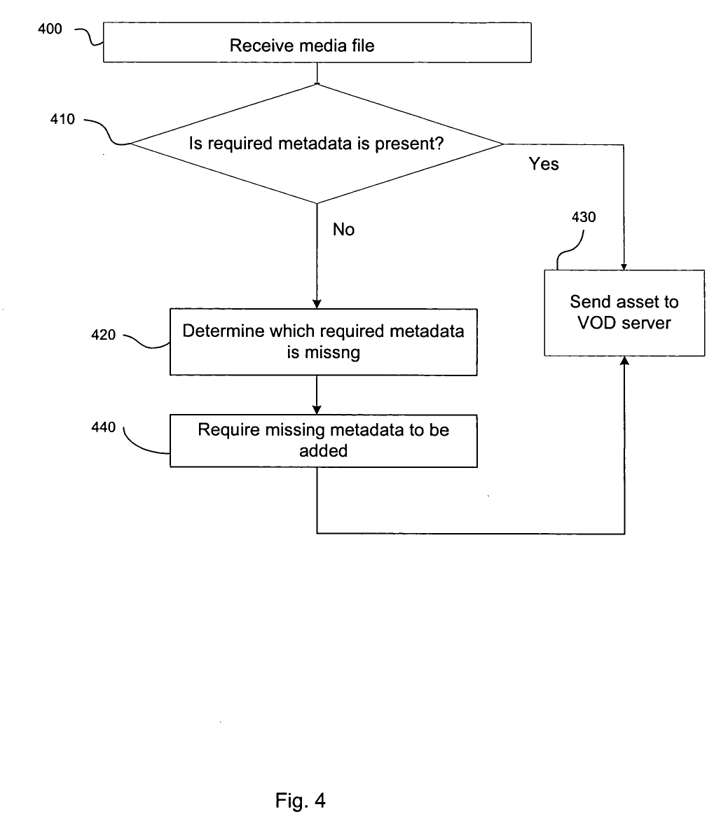

FIG. 4 illustrates a flowchart in accordance with embodiments of the present invention. In step 400, a media file is received. The media file could be a single media file, a package of media files, or a plurality of individual media files. The media files could comprise a video program such as a movie, an audio file, an image file, etc., and may be received in any of a plurality of formats, as described above, such as XML, MPEG, video tape, etc.

In step 410, the present invention uses a computing device to automatically determine whether certain metadata is associated with the media file, with the package of media files, or with each of the plurality of received media files. Any of the metadata may be designated by the service provider as required even if not designated as required by the above-described CableLabs® specifications. The computing device may be programmed to only look for metadata designated by the service provider or user as required. In addition, the computing device may be further programmed to look for additional metadata that may be designated as optional metadata, as further explained below. The computing device may be further programmed to do any additional tasks as desired at this stage.

If the computing device determines that the metadata it is looking for is associated with the corresponding media file in step 410, the computing device 310 may send the asset (the media file and associated metadata) to the VOD server in step 430, where the asset may be loaded to become available for access by customers. If the computing device 310 determines that some or all of the required metadata is not associated with the media file, the computing device determines which of the required metadata is missing in step 420. Then, in step 440, the computing device will require the missing metadata to be added.

The missing data may be required to be added by indicating to an operator which metadata is missing on a display, which is part of the computing device, such as the display 140 shown in FIG. 1. The operator may enter missing metadata through a user input, such as user input 130. Alternatively, upon seeing that some or all of the metadata is missing, the operator could request the content supplier to resend the media file or files with the missing metadata, and re-enter the new media files into the computing device, where they may again be checked for required metadata. Once the required metadata has been added in step 440, the asset or assets may be sent to be loaded onto the VOD server 330.

A missing or corrupt media file may be required to be added by indicating to an operator which media file is missing on a display, which is part of the computing device, such as the display 140 in FIG. 1. The operator may add a missing or corrected media file through the user input, such as user input 130. Alternatively, upon seeing that some or all of the media file is missing or corrupted, the operator could request the content supplier to re-send the media file or files with the metadata, and re-enter the new media files into the computing device, where they may again be checked for required metadata. Once the corrected media file has been added, the asset or assets may be sent to be loaded onto the VOD server 330.

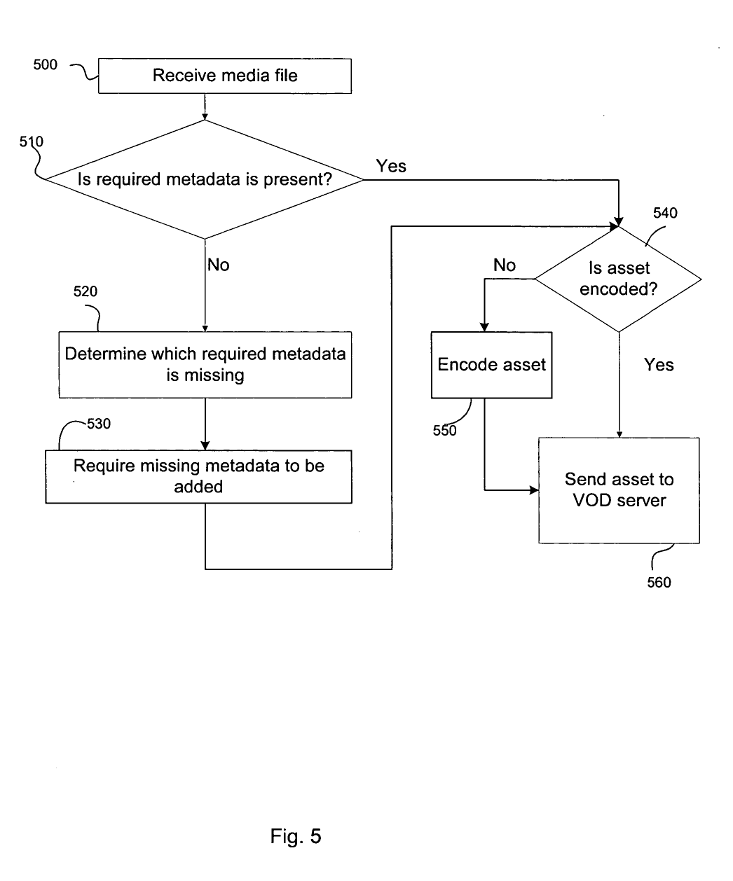

FIG. 5 illustrates a flowchart in accordance with embodiments of the present invention. Steps 500, 510, 520 and 530 are identical to steps 400, 410, 420 and 440 of FIG. 4, respectively, and will not be further discussed. After the required metadata is determined to be present in steps 510 or 530, the computing device determines whether the asset is encoded in step 540. If the asset is encoded, the asset may be sent to the VOD server 330. If the asset is determined to not be encoded in step 540, the asset may be encoded in step 550. The asset may be encoded by the computing device 310, or may be sent to another device to be encoded. The computing device 310 may generate an indication on its display to an operator that the asset is not encoded, and may display a query as to whether the asset should be encoded. The computing device may be programmed with appropriate software to carry out an encoding operation or the computing device may send the asset to another computing device for encoding, such as a computing device dedicated to encoding. Once the asset is encoded in step 560, the asset is sent to the VOD server 330 in step 560.

As described above, the computing device 310 may be programmed with appropriate software to carry out the described functionality. In preparing the media files to be placed on the server, the software may carry out additional functionality in conjunction with an operator or user. For example, the computing device may examine a received media file and place the media file in one of a plurality of states depending on whether the received media file has associated therewith the required metadata and whether the media files is encoded. While any number of states may be used, none of the states are necessary to practice the embodiments of the above-described invention. Each of these states may require an operator to perform certain steps before the media file and/or associated metadata is moved to a next state. For example, the states may include a standby state, a new state, a received state, an encoded state, a loaded state, a production state, a revised state, a retired state, a deleted state, and a destroyed state. The states may be used by the computing device to create, manipulate, and revise an asset as it moves through its lifecycle. An asset or media file may be moved from one state to another, and may require that a user perform certain tasks before it may be moved to a next state. These tasks may be in addition to those described above.

The validation of required metadata described above may occur in the standby state, before the asset is allowed to move to the new state. This state or any other state may require the validation of a portion or all of the metadata. If the required metadata is not present, the computing device may prevent the asset from moving to the new state. The standby state may be modified to require validation of metadata that may be designated optional, as well as required metadata. Each of the states may perform validations of certain functionality or features, or require an operator to perform certain tasks. The validation of metadata and validation of encoded media may occur at any of the states. These states are optional, and fewer or no states may be used.

Several embodiments of the present invention are specifically illustrated and described herein. However, it will be appreciated that modifications and variations of the present invention are covered by the above teachings and within the purview of the appended claims without departing from the spirit and intended scope of the invention.

1. A method of preparing an asset for placement on a server, the asset including a media file and corresponding metadata elements, comprising:
receiving the media file;
automatically determining whether all required metadata elements are associated with the received media file;
if all of the required metadata elements are not associated with the received media file, determining which of the required metadata elements are missing; and
requiring the missing metadata elements to be added before the asset is placed on the server.

2. The method of claim 1, wherein the corresponding metadata elements include the required metadata elements and optional metadata elements.

3. The method of claim 2, wherein the required metadata elements include at least one of a title, a description, an activate date, a deactivate date, a subscription group, categories, a release year, a length, a rental period, a grace period, and a price.

4. The method of claim 2, wherein the optional metadata elements include a summary, an episode name, and episode ID, an MSO rating, advisories, an indication of closed captioning, a country of origin, and an encryption flag.

5. The method of claim 1, wherein requiring the missing metadata elements to be added comprises generating an indication to an operator of which metadata elements are missing, and asking the operator to have the missing metadata elements added.

6. The method of claim 1, further comprising automatically determining whether the media file is encoded.

7. The method of claim 6, further comprising, if it is determined that the media file is not encoded, requiring encoding of the media file before the asset is placed on the server.

8. The method of claim 7, wherein requiring encoding of the media file before the asset is placed on the server comprises generating an indication to an operator that the media file is not encoded, and asking the operator to have the media file encoded.

9. An apparatus for preparing an asset for placement on a server, the asset including a media file and corresponding metadata elements, comprising:
a processor;
a memory to store instructions to be executed by the processor, the instructions including instructions to:
receive the media file;
automatically determine whether all required metadata elements are associated with the received media file;
if all of the required metadata elements are not associated with the received media file, determine which of the required metadata elements are missing; and
require the missing metadata elements to be added before the asset is placed on the server.

10. The apparatus of claim 9, wherein the corresponding metadata elements include the required metadata elements and optional metadata elements.

11. The apparatus of claim 10, wherein the required metadata elements include at least one of a title, a description, an activate date, a deactivate date, a subscription group, categories, a release year, a length, a rental period, a grace period, and a price.

12. The apparatus of claim 10, wherein the optional metadata elements include a summary, an episode name, and episode ID, an MSO rating, advisories, an indication of closed captioning, a country of origin, and an encryption flag.

13. The apparatus of claim 9, wherein the instructions requiring the missing metadata elements to be added comprise instructions to generate an indication to an operator of which metadata elements are missing, and ask the operator to have the missing metadata elements added.

14. The apparatus of claim 9, wherein the memory further includes instructions to determine whether the media file is encoded.

15. The apparatus of claim 14, wherein the memory further includes instructions to require encoding of the media file before the asset is placed on the server, if it is determined that the media file is not encoded.

16. The apparatus of claim 15, wherein the instructions to require encoding of the media file before the asset is placed on the server comprise instructions to generate an indication to an operator that the media file is not encoded, and ask the operator to have the media file encoded.

17. A method of preparing a video-on-demand asset for placement on a video-on-demand server, the video-on-demand asset including a media file and corresponding metadata elements, comprising:
receiving the media file;
determining whether all of a plurality of required metadata elements are associated with the received media file;
if all of the required metadata elements are not associated with the received media file, determining which of the required metadata elements are missing;
requiring the missing metadata elements to be added;
determining if the media file is encoded; and
if the media file is not encoded, requiring the media file to be encoded before the video-on demand asset is placed on the video-on-demand server.

18. The method of claim 17, wherein the corresponding metadata elements include the required metadata elements and optional metadata elements.

19. The method of claim 18, wherein the required metadata elements include at least one of a title, a description, an activate date, a deactivate date, a subscription group, categories, a release year, a length, a rental period, a grace period, and a price.

20. The method of claim 18, wherein the optional metadata elements include a summary, an episode name, and episode ID, an MSO rating, advisories, an indication of closed captioning, a country of origin, and an encryption flag.

21. The method of claim 17, wherein requiring the missing metadata elements to be added comprises generating an indication to an operator of which metadata elements are missing, and asking the operator to have the missing metadata elements added.

22. The method of claim 17, wherein requiring encoding of the media file before the asset is placed on the server comprises generating an indication to an operator that the media file is not encoded, and asking the operator to have the media file encoded.

23. An apparatus for preparing an video-on-demand asset for placement on a video-on-demand server, the video-on-demand asset including a media file and corresponding metadata elements, comprising:
a processor;
a memory to store instructions to be executed by the processor, the instructions including instructions to:
receive the media file;
determine whether all of a plurality of required metadata elements are associated with the received media file;
if all of the required metadata elements are not associated with the received media file, determine which of the required metadata elements are missing;
require the missing metadata elements to be added;
determine if the media file is encoded; and
if the media file is not encoded, require the media file to be encoded before the video-on demand asset is placed on the video-on-demand server.

24. The apparatus of claim 23, wherein the corresponding metadata elements include the required metadata elements and optional metadata elements.

25. The apparatus of claim 24, wherein the required metadata elements include at least one of a title, a description, an activate date, a deactivate date, a subscription group, categories, a release year, a length, a rental period, a grace period, and a price.

26. The apparatus of claim 24, wherein the optional metadata elements include a summary, an episode name, and episode ID, an MSO rating, advisories, an indication of closed captioning, a country of origin, and an encryption flag.

27. The apparatus of claim 23, wherein the instructions that require the missing metadata elements to be added comprise instructions to generate an indication to an operator of which metadata elements are missing, and asking the operator to have the missing metadata elements added.

28. The apparatus of claim 23, wherein the instructions that require encoding of the media file before the asset is placed on the server comprise instructions to generate an indication to an operator that the media file is not encoded, and ask the operator to have the media file encoded.

29. A machine-readable medium having stored thereon a plurality of executable instructions for preparing an asset for placement on a server, the asset including a media file and corresponding metadata elements, the plurality of instructions comprising instructions to:
receive the media file;
automatically determine whether all required metadata elements are associated with the received media file;
if all of the required metadata elements are not associated with the received media file, determine which of the required metadata elements are missing; and
require the missing metadata elements to be added before the asset is placed on the server.

30. A machine-readable medium having stored thereon a plurality of executable instructions for preparing an asset for placement on a server, the asset including a media file and corresponding metadata elements, the plurality of instructions comprising instructions to:
receive the media file;
determine whether all of a plurality of required metadata elements are associated with the received media file;
if all of the required metadata elements are not associated with the received media file, determine which of the required metadata elements are missing;
require the missing metadata elements to be added;
determine if the media file is encoded; and
if the media file is not encoded, require the media file to be encoded before the video-on demand asset is placed on the video-on-demand server.
